(19) United States
(12) Patent Application Publication
(10) Pub. No.: US 2020/0296952 A1
(43) Pub. Date: Sep. 24, 2020

(54) Rodent Trap

(71) Applicant: Kinney ASWD Holding Company, LLC, Madison, AL (US)

(72) Inventor: Gary Wayne Kinney, Madison, AL (US)

(73) Assignee: Kinney ASWD Holding Company, LLC, Madison, AL (US)

(21) Appl. No.: 16/356,617

(22) Filed: Mar. 18, 2019

(51) Int. Cl. A01M 23/08

(52) U.S. Cl. CPC A01M 23/08; A01M 2200/00

(57) ABSTRACT

A device for catching rodents has a bottle comprising a generally cylindrical circular opening, an outside of the opening having a plurality of threads and a lid coupled to the plurality of threads, the lid having a first collar defining an opening, the lid further comprising a plurality of protrusions that extend at an acute angle relative to the lid and are oriented to extend toward the center of the bottle.

### BACKGROUND

There are many different types of rodent traps capable of catching, for example, mice and rats. Oftentimes these rodent traps are designed to catch and kill the rodent. As a mere example, there is the spring-loaded bar trap. The spring-loaded bar trap has a spring-loaded arm that when activated by the rodent, releases a hammer, which kills the rodent.

There are electric rodent traps. An electric rodent trap has two electrodes located between the entrance and the bait. When the rodent enters the electric rodent trap, it completes the circuit and a lethal dose of electricity is delivered to the rodent.

There are hundreds of different types of rodent traps both kill and no-kill traps for use in stopping rodent manifestation.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is an exploded perspective view of a rodent trap in accordance with an embodiment of the present disclosure.

FIG. 2 is a cross-sectional view of the rodent trap of FIG. 1 showing the lid inserted on a bottle.

FIG. 3 is side cross-sectional view of the rodent trap of FIG. 1 showing the lid removed from the bottle.

FIG. 4 is a top view of the lid shown in FIG. 3.

FIG. 5 is a side cross-sectional view of the rodent trap of FIG. 1 showing the lid inserted on the bottle.

FIG. 6 is a perspective view of another lid in accordance with an embodiment of the present disclosure using wires as protrusions.

FIG. 7 is side cross-sectional view of the rodent trap of FIG. 1 showing the lid of FIG. 6 removed from the bottle.

FIG. 8 is a side cross-sectional view of the rodent trap of FIG. 1 showing the lid of FIG. 6 inserted on the bottle.

FIG. 9 is a cross-sectional view of the rodent trap of FIG. 8 showing the lid coupled to the bottle.

FIG. 10 is a cross-sectional view of another exemplary lid in accordance with an embodiment of the present disclosure.

FIG. 11 is a cross-sectional view showing the lid of FIG. 10 coupled to a mouth of a bottle.

FIG. 12 is a top view of an exemplary lid in accordance with an embodiment of the present disclosure.

FIG. 13 is a side view of the lid of FIG. 12.

FIG. 14 is another side view of the lid of FIG. 12 at a different angle.

FIG. 15 is a cross-sectional view of a rodent trap in accordance with an embodiment of the present disclosure shewing the lid of FIG. 12 coupled to a bottle.

### DETAILED DESCRIPTION

The present disclosure describes a rodent trap in accordance with an embodiment of the present disclosure. The rodent trap comprises a generally cylindrical bottle with threads on the opening tor receiving a lid having threads. The lid comprises a plurality of protrusions that are angularly placed inwardly. Further, the lid comprises an opening. In use, a rodent enters the lid through live opening to obtain bait placed in the generally cylindrical bottle. Once the rodent is inside the bottle, the rodent is unable to escape because of the angularly placed protrusions.

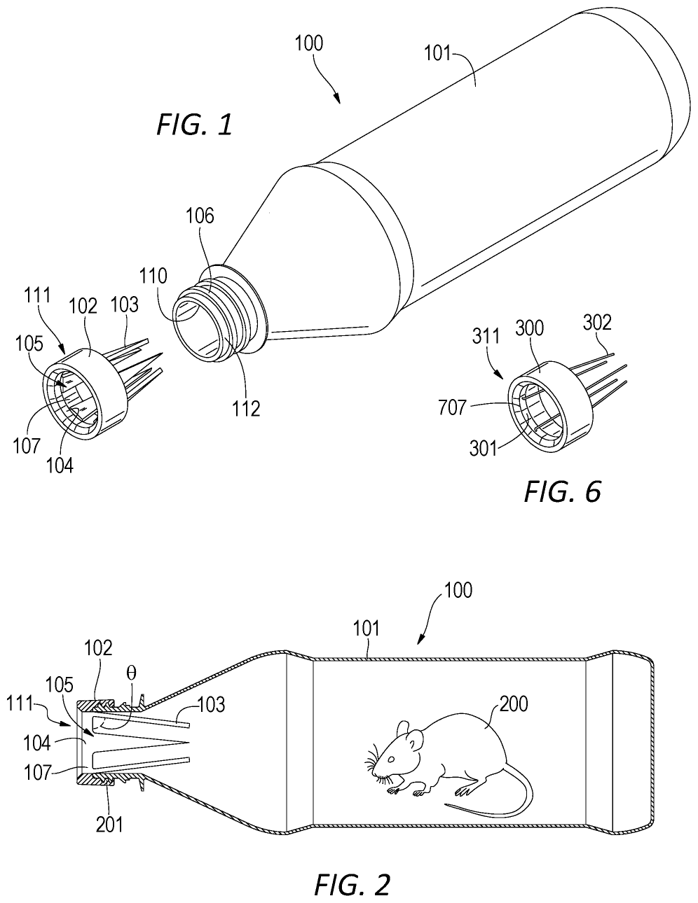

FIG. 1 is a perspective view of a rodent trap 100 in accordance with an embodiment of the present disclosure. The rodent trap 100 comprises a generally cylindrical bottle 101 that further has a generally circular and cylindrical opening 110. On an outside surface 112 of the opening 110 are a plurality of threads 106 for receiving threads of a lid 111.

The rodent trap 100 further comprises a lid 111. The lid 111 comprises a cylindrical collar 102. The cylindrical collar 102 comprises an inside opening circular surface 104, and on this surface 104 are threads for mating with the threads 106 of the opening 110 of the bottle 100.

Additionally, the lid 111 comprises a single-molded piece 105 that comprises a collar 107 to which a plurality of protrusions 103 are integrally formed therewith. As will be shown further, these protrusions 103 are disposed at an acute angle relative to the lid 111 so that the protrusions extend inwardly toward the center of the bottle 101. Note that in one embodiment the protrusions are metal. However, in other embodiments other types of material may be used, e.g., plastic. Further note that the protrusions may be triangularly shaped. However, they may be shaped differently in other embodiments.

FIG. 2 is a cross-sectional view of the rodent trap 100. The rodent trap comprises the bottle 101 and coupled to the bottle is the lid 111. Notably, threads 201 of the lid 111 couple with the threads 106 in the outside surface 112 (FIG. 1) of the circular opening 110.

The lid 111 further comprises a cylindrical collar 102 that forms an opening 104 to the inside of the bottle 101. Further, the lid 111 comprises a collar 107 that is integrally formed with the plurality of protrusions 103. Note that the protrusions 103 are placed at an acute angle θ relative to the lid 111 so that the protrusions extend inwardly and toward the center of the bottle 101.

Thus, during use a rodent may be able to enter the bottle 101 through the opening 104. However, once the rodent is in the bottle, he will be unable to get out because the angled protrusions block his way to the opening 104. This is a catch and release form of a rodent trap.

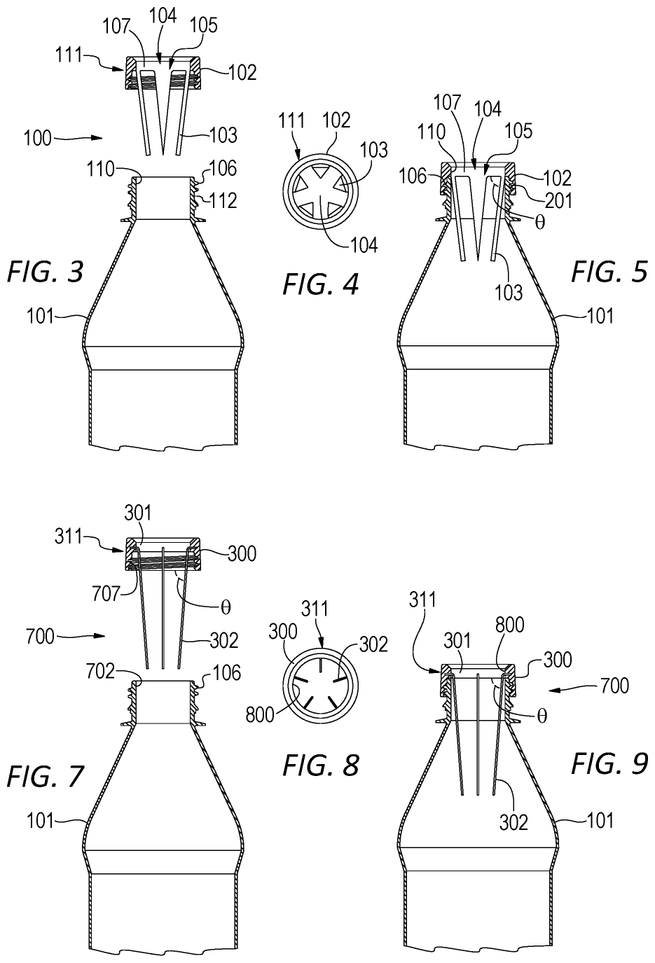

FIG. 3 is a side cross-sectional view of the rodent trap 100 with the lid not inserted. The rodent trap 100 comprises the bottle 100 that has the opening 110 and a plurality of threads on the outside surface of the opening 110. The threads 106 are configured for receiving respective threads on the lid 111.

The lid 111 comprises the collar 102 that forms an opening 104. Within the collar 102 is a single-molded piece 105 comprising a collar 107 and a plurality of protrusions 103 that extend from the collar 107. Note that these protrusions 103 extend at an acute angle θ relative to the lid 111 so that they are oriented toward the center of the bottle 100.

FIG. 4 is a top view of a lid 111. The top view shows the opening 104 and the plurality of protrusions that extend toward the center of the bottle 100.

FIG. 5 is a side cross-sectional view of the rodent trap 100 with the lid 111 inserted. The rodent trap 100 comprises the bottle 100 that has the opening 110 and a plurality of threads 106 on the outside surface of the opening 110. The threads 106 are configured for receiving respective threads 201 on the lid 111.

The lid 111 comprises the collar 102 that forms an opening 104. Within the collar 102 is a single-molded piece 105 comprising a collar 107 and a plurality of protrusions 103 that extend from the collar 107. Note that these protrusions 103 extend at an acute angle θ relative to the lid 111 so that they are oriented toward the center of the bottle 100.

FIG. 6 is another embodiment of a lid 311 for use in a rodent trap. The lid comprises a collar 300 with an inside surface 301. The inside surface comprises a plurality of threads 707. The lid 311 further comprises a plurality of protrusions 302 that are coupled to an inside surface 301 of the lid 311. Note that in one embodiment, the protrusions 302 may be made of metal. However, other types of material are possible in other embodiments.

FIG. 7 is a rodent trap 700 using the lid 311 also shown in FIG. 6. The rodent trap 700 comprises a bottle 701. The bottle 701 has a generally circular and cylindrical opening 702. On an outside surface of the opening 702 are a plurality of threads 706.

The lid 311 comprises a collar 300 and on an inside surface of the collar are a plurality of threads 707 for making with the threads 706 of the opening 702 of the bottle 701. Further, coupled to the inside surface of the collar 300 are a plurality of wires. These wires 302 are disposed at an acute angle ∅ relative to the lid 311.

FIG. 8 is a top view of the lid 311. The lid comprises a collar, and a plurality of wires are coupled to an inside surface 800 of the lid 311. Note that the wires are positioned so that they extend inward into the bottle 701.

FIG. 9 is a cross-sectional view of the rodent trap 700 showing the lid 311 coupled to the bottle 701. In the embodiment shown, the wires 302 extend an acute angle ∅ relative to the lid 311. The wires 302 are coupled to the inside surface 800 of the collar 300. Thereby, creating an opening 301 in the lid 311.

In use, a rodent enters the bottle 700 through the opening 301. He travels past the wires 302 to bait (not shown) contained within the bottle 701. Because the wires 302 are disposed at an acute angle relative to the lid 311 so that they extend toward the center of the bottle 701, the rodent cannot escape once he is trapped in the bottle. This type of rodent trap serves as a catch and release.

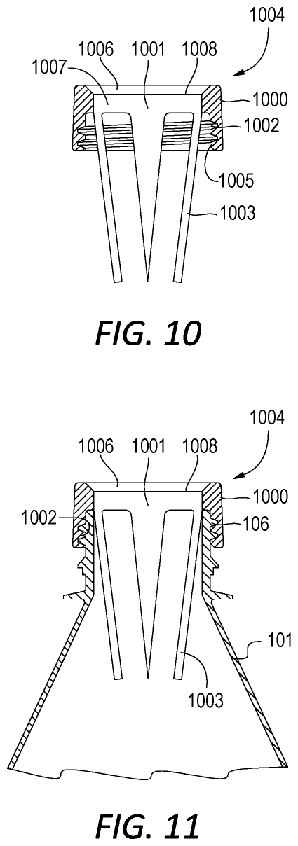

FIG. 10 is a cross-sectional view of a lid 1004 in accordance with an embodiment of the present disclosure. The lid 1004 is comprised of a cap 1000 and a cap insert 1001. The cap insert 1001 is affixed to the cap 1000, for example via epoxy. There are openings 1006 and 1008 in the cap 1000 and cap insert 1001 through which rodents may travel.

The cap insert 1001 comprises a collar 1007 integrally formed with a plurality of spiked protrusions 1003. These protrusions 1003 are disposed at an angle, e.g., an acute angle, relative to a collar relative to the collar 1007 so that the protrusions 1003 extend inwardly into a bottle when the lid 1004 is placed on a bottle (not shown). Note that in one embodiment the protrusions are metal. However, in other embodiments other types of material may be used, e.g., plastic. Further note that the protrusions may be triangularly shaped. However, they may be shaped differently in other embodiments.

The cap 1000 comprises a plurality of threads 1002 on an inside surface 1005 of the cap 1000. In this regard, the cap 1000 and the attached insert 1001 can be threadedly coupled to a bottle, which is shown in FIG. 11.

As shown in FIG. 11, the lid 1004 comprising the cap 1000 and the insert 1001 is coupled to a bottle 1100. In this regard, the threads 1002 on the cap 1000 threadedly couple to the threads 1101 on the bottle 1100.

In use, bait (not shown) is put in the bottle 1100. The lid 1004 is coupled to the bottle 1100. The bottle is placed on its side. A rodent can then enter the bottle 1100 through the openings 1006 and 1008. The rodent is able to enter the bottle 1100 through the flexible protrusions 1003. However, once the rodent is in the bottle 1100, he cannot exit because of the angular disposition of the protrusions 1003. The opening created by the protrusions 1003 is not large enough for the rodent to exit the bottle 1100. In this regard, when a rodent is entering the bottle 1100 the protrusions expand thereby allowing the rodent to enter. However, once the rodent is in the bottle 1100, the protrusions contract making the exit way smaller. Thus, the rodent cannot escape.

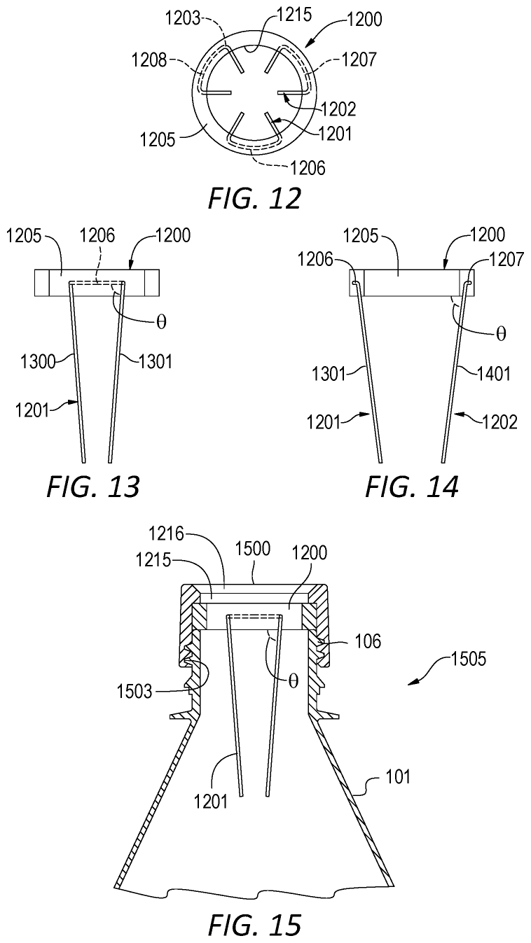

FIG. 12 is a top view of an exemplary lid 1200 in accordance with an embodiment of the present disclosure. The lid 1200 is coupled with a cap, and the lid and the cap are placed on a bottle.

The lid 1200 comprises a circular collar 1205 and an opening 1215 therein. Embedded within the circular collar 1205 are a plurality of wires 1201-1203. Note that the lid 1200 may be made of plastic. However, other materials are possible in other embodiments. Further, the wires 1201-1203 may be made of metal. However, other materials are possible in other embodiments.

Each wire 1201-1203 is curved and bent such that two portions of each of the wires 1201-1203 protrude from the collar 1205 and bent portions 1206-1208 are embedded in the collar 1205.

Note that the portions of the wires 1201-1203 that extend from the collar 1205 are bent inward at an acute angle relative to collar 1205. Those bends in the wires 1201-1203 ensure that a rodent cannot escape once the rodent has entered the bottle.

FIG. 13 is a side view of the lid 1200. Notably, the curved and bent portion 1206 of the wire 1201 is embedded in the collar 1205. Further, two portions 1300 and 1301 of the wire 1201 protrude from the collar 1205 at an angle θ. The two portions 1300 and 1301 of the wire 1201 protrude from the collar 1205 are also bent toward each other.

FIG. 14 is a side view of the lid 1200 taken from a different perspective than the view in FIG. 13. In this regard, embedded in the collar 1205 are wires 1201 and 1202. Notably, the curved and bent portion 1206 of the wire 1201 is embedded in the collar 1205, and the curved and bent portion 1207 of the wire 1201 is embedded in the collar 1205. Further, portions 1301 and 1401 of the wires 1201 and 1202, respectively protrude at an angle θ from the collar 205 such that the wire 1301 extends toward wire 1401 and wire 1401 extends toward wire 1301.

FIG. 15 is a rodent trap 1505 in accordance with an embodiment of the present disclosure. The rodent trap 1505 comprises the cap 1504 on which are threads 1503. The rodent trap 1505 further is coupled to the lid 1200 that is coupled to the inside of the cap 1504 via an attachment mechanism, e.g., epoxy.

The rodent trap 1505 further comprises the bottle 1502. On its outside surface, the bottle comprises a plurality of threads 1501.

In use, bait is put in the bottle 1502. The cap 1500 with the lid 1200 coupled therein is attached to the bottle 1502 by the threads 1501 on the bottle and threads 2503 on the cap 1500. The bottle 1502 is strategically placed on its side. When a rodent goes though the openings 1215 and 1216 to retrieve the bait, they fit in the bottle 1502, because the wires 1201-1203 (FIG. 12) axe slightly flexible and expand as the rodents move through the wires 1201-1203. The wires 1201-1203 separate when the rodent is entering the bottle 1502. However, once the rodent is in the bottle 2502 the wires 1201-1203 contract to their resting positions, thereby narrowing the pathway so that the rodent cannot escape.

1. A device for catching rodents, comprising:
a bottle comprising a generally cylindrical circular first opening, an outside of the first opening having a plurality of threads;
a first circular collar threadedly coupled to the plurality of threads on the outside of the first opening, the first circular collar comprising a second opening therein exposing an inside compartment of the bottle without obstruction to the inside compartment; and
a second circular collar defining a third opening, the second circular collar is not a part of the first circular collar but is a distinct and separate component, the second circular collar fits within the first circular collar, the second circular collar further comprising a plurality of protrusions separate and apart from the second circular collar, the protrusions are affixed flexibly to an inside wall of the second circular collar and extend at an angle such that the plurality of protrusions are oriented to extend toward the center of the bottle.

2. (canceled)

3. (canceled)

4. The device for catching rodents of claim 1, wherein the protrusions are a plurality of plastic triangularly-shaped protrusions.

5. The device for catching rodents of claim 4, wherein the plurality of plastic triangularly-shaped protrusions are integral with the second circular collar that resides within and is coupled to the first circular collar.

6. A device for catching rodents, comprising:
a bottle comprising a generally cylindrical circular first opening, an outside of the first opening having a plurality of threads;
a first circular collar threadedly coupled to the plurality of threads on the outside of the first opening, the first circular collar comprising a second opening therein exposing an inside compartment of the bottle without obstruction to the inside compartment; and
a plurality of wires completely inside the device and the wires do not extend out the first opening and are not integral and not coupled to an outside wall of the device but instead the wires are coupled to an inside surface of the first circular collar, the plurality of wires disposed at an acute angle relative to the circular collar so that they extend inward into the bottle.

7. The device for catching rodents of claim 6, wherein the wires are made of a flexible metal.

8. A device for catching rodents, comprising:
a bottle comprising a generally cylindrical circular first opening, an outside of the first opening having a plurality of threads;
a circular cap threadedly coupled to the plurality of threads on the outside of the first opening, the first circular cap comprising a second opening therein exposing an inside compartment of the bottle without obstruction to the inside compartment; and
a cap insert affixed to an inside surface of the circular cap via epoxy, the cap insert is a separate and distinct component from the circular cap, the cap insert comprising a third opening such that a rodent can enter an inside cavity of the bottle, the cap insert comprising a plurality of wires affixed completely inside the device to an inside surface of the cap insert not to the outside surface of the device, the wires disposed at an acute angle relative to the circular cap so that the wires extend inwardly into the bottle.

9. (canceled)
